(19) United States
(12) Patent Application Publication
(10) Pub. No.: US 2025/0368143 A1
(43) Pub. Date: Dec. 4, 2025

(54) Vehicle Roof Ladder-Securing Device

(71) Applicants: Dale Keller, Minot, ND (US); Peggy Keller, Minot, ND (US)

(72) Inventors: Dale Keller, Minot, ND (US); Peggy Keller, Minot, ND (US)

(21) Appl. No.: 19/084,205

(22) Filed: Mar. 19, 2025

Related U.S. Application Data
(60) Provisional application No. 63/654,132, filed on May 31, 2024.

(51) Int. Cl. B60R 9/042

(52) U.S. Cl. CPC B60R 9/0423

(57) ABSTRACT

A vehicle roof ladder-securing device is provided. The device is designed for securing ladders onto vehicle roof racks. The device comprises a rear frame member and a front frame member, each featuring channels containing springs and fasteners that engage and secure the edges of a ladder. The fasteners, including repositionable fasteners, move within the channels to grip the ladder under spring tension, while locking mechanisms ensure a ladder remains secured to the device during use. Both frame members attach to the vehicle roof rack using various fasteners, allowing flexibility in mounting. The device also includes a fastener between ladder rungs to prevent forward and backward ladder shifting.

### CROSS-REFERENCE TO RELATED APPLICATION

The present application claims priority to, and the benefit of, U.S. Provisional Application No. 63/654,132, which was filed on May 31, 2024, and is incorporated herein by reference in its entirety.

### FIELD OF THE INVENTION

The present invention relates generally to the field of ladder-securing devices for vehicles. More specifically, the present invention relates to a vehicle roof ladder-securing device that provides a spring-loaded mounting mechanism for securing ladders to a vehicle roof rack. Accordingly, the present disclosure makes specific reference thereto. Nonetheless, it is to be appreciated that aspects of the present invention are also equally applicable to other like applications, devices, and methods of manufacture.

### BACKGROUND

Individuals who require frequent access to ladders for various tasks, whether for professional jobs such as construction, painting, maintenance, or even for home improvement projects, often face the need to transport these ladders from one location to another. Transporting a ladder, however, can be a tricky and time-consuming task. When placed in or on a vehicle, such as a pickup truck, van, SUV, or even larger commercial vehicles, ladders have the potential to shift, slide, or bounce around if they are not adequately secured. This movement can lead to several problems.

Firstly, an unsecured ladder can cause significant damage to the vehicle itself, potentially scratching or denting the interior or exterior. Additionally, the ladder may suffer wear and tear or structural damage, reducing its lifespan and usability. Beyond the risk of physical damage, an improperly secured ladder presents a safety hazard—not only to the person transporting it but also to other drivers and pedestrians on the road. A ladder that is not properly fastened can become a dangerous projectile in the event of a sudden stop or accident, leading to potentially serious consequences.

Securing a ladder to a vehicle may seem straightforward, but many people find the process frustrating and time-consuming, particularly when they need to transport other tools, equipment, or materials as well. The task often involves manually strapping or tying the ladder down, which can be inefficient and unreliable if done hastily or without the right equipment. As a result, people may end up wasting considerable time trying to properly attach ladders to their vehicles before each trip, taking time away from their actual work. Furthermore, without the proper tools or techniques for securing the ladder, it can take multiple attempts, leading to further delays and frustrations.

Therefore, there exists a long-felt need in the art for a device for securing a ladder to a vehicle. There also exists a long-felt need in the art for a vehicle roof ladder-securing device. More specifically, there exists a long-felt need in the art for a vehicle roof ladder-securing device for securing a ladder to a vehicle wherein the device prevents movement and shifting of the ladder once attached to the vehicle. In addition, there exists a long-felt need in the art for a vehicle roof ladder-securing device for securing a ladder to a vehicle wherein the device prevents movement and shifting of the ladder once attached to the vehicle wherein a ladder can easily and quickly be secured to a vehicle using the device.

The subject matter disclosed and claimed herein, in one embodiment thereof, comprises a vehicle roof ladder-securing device. The device is designed for securing ladders onto vehicle roof racks. The device comprises a rear frame member and a front frame member, each featuring channels containing springs and fasteners that engage and secure the edges of a ladder. The fasteners, including repositionable fasteners, move within the channels to grip the ladder under spring tension, while locking mechanisms ensure a ladder remains secured to the device during use. Both frame members attach to the vehicle roof rack using various fasteners, allowing flexibility in mounting. The device also includes a fastener between ladder rungs to prevent forward and backward ladder shifting.

In this manner, the vehicle roof ladder-securing device of the present invention accomplishes all the forgoing objectives and provides a device for securing a ladder to a vehicle. More specifically, the device prevents movement and shifting of the ladder once attached to the vehicle. In addition, the device allows a ladder to easily and quickly be secured to a vehicle using the device.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle roof ladder-securing device comprised of a rear frame member and a front frame member, which each attach to a roof rack (or other area) of a vehicle, wherein each frame member is comprised of at least one spring, at least one fastener, and at least one locking mechanism. Each frame member may be comprised of at least one fastener that allows each frame member to be attached to a roof rack of a vehicle in a horizontal position (i.e., across a vehicle).

The rear frame member is comprised of a channel, wherein at least one spring is positioned within the channel. More specifically, the spring is attached to a fastener of the frame member. The fastener is preferably an angled bracket with a top surface parallel to a top surface of the frame member that secures a lip of a first edge of a ladder frame to prevent the ladder from falling off a vehicle roof. The spring is also attached to a repositionable fastener that moves within the channel, wherein the fastener can be pulled away from the first fastener such that the first fastener engages a first edge of a ladder frame once the ladder is placed across the top surface of the member. The repositionable fastener then can be released such that it engages a second edge of the ladder frame, wherein the ladder is then secured (via the tension of the spring) between the first fastener and the repositionable fastener. Once in this position, at least one locking mechanism can be engaged to prevent movement of the repositionable fastener and/or spring within the channel and/or to prevent movement of the ladder by contacting/engaging the ladder.

The front frame member is also comprised of a channel that preferably runs a length within the frame member. At least one spring is positioned within the channel. More specifically, the spring is attached to a fastener of the frame member. The fastener is preferably an angled bracket with a top surface parallel to a top surface of the frame member that secures a lip of a first edge of a ladder frame to prevent the ladder from falling off a vehicle roof. The device may also have a fastener in the form of a bracket that is perpendicular to a top surface of the frame member that is positioned between rungs of a ladder frame to prevent the ladder from shifting forward or backward off a vehicle roof. The spring is also attached to a repositionable fastener that moves within the channel. The fastener can be pulled away from the first fastener such that the first fastener engages a first edge of a ladder frame once the ladder is placed across the top surface of the member. The repositionable fastener then can be released such that it engages a second edge of the ladder frame, wherein the ladder is then secured (via tension of the spring) between the first fastener and the repositionable fastener. Once in this position, at least one locking mechanism can be engaged to prevent movement of the repositionable fastener and/or spring within the channel. This prevents the repositionable fastener from losing contact with the ladder during use.

Accordingly, the vehicle roof ladder-securing device of the present invention is particularly advantageous as it provides a device for securing a ladder to a vehicle. More specifically, the device prevents movement and shifting of the ladder once attached to the vehicle. In addition, the device allows a ladder to easily and quickly be secured to a vehicle using the device. In this manner, the vehicle roof ladder-securing device overcomes the limitations of existing methods and devices used to secure a ladder to a vehicle that is known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a rear perspective view of a rear frame member of one potential embodiment of a vehicle roof ladder-securing device of the present invention in accordance with the disclosed architecture;

FIG. 2 illustrates a perspective view of a rear frame member of one potential embodiment of a vehicle roof ladder-securing device while a ladder is secured to the frame member of the present invention in accordance with the disclosed architecture;

FIG. 3 illustrates a side perspective view of a front frame member of one potential embodiment of a vehicle roof ladder-securing device of the present invention in accordance with the disclosed architecture; and

FIG. 4 illustrates a flowchart of a method of using one potential embodiment of a vehicle roof ladder-securing device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for securing a ladder to a vehicle. There also exists a long-felt need in the art for a vehicle roof ladder-securing device. More specifically, there exists a long-felt need in the art for a vehicle roof ladder-securing device for securing a ladder to a vehicle wherein the device prevents movement and shifting of the ladder once attached to the vehicle. In addition, there exists a long-felt need in the art for a vehicle roof ladder-securing device for securing a ladder to a vehicle wherein the device prevents movement and shifting of the ladder once attached to the vehicle wherein a ladder can easily and quickly be secured to a vehicle using the device.

The present invention, in one exemplary embodiment, is comprised of a vehicle roof ladder-securing device. The device is comprised of a rear frame member and a front frame member, which each attach to a roof rack (or other area) of a vehicle, wherein each frame member is comprised of at least one spring, at least one fastener, and at least one locking mechanism. Each frame member may be comprised of at least one fastener that allows each frame member to be attached to a roof rack of a vehicle in a horizontal position (i.e., across a vehicle).

The rear frame member is comprised of a channel, wherein at least one spring is positioned within the channel. More specifically, the spring is attached to a fastener of the frame member. The fastener is preferably an angled bracket with a top surface parallel to a top surface of the frame member that secures a lip of a first edge of a ladder frame to prevent the ladder from falling off a vehicle roof. The spring is also attached to a repositionable fastener that moves within the channel, wherein the fastener can be pulled away from the first fastener such that the first fastener engages a first edge of a ladder frame once the ladder is placed across the top surface of the member. The repositionable fastener then can be released such that it engages a second edge of the ladder frame, wherein the ladder is then secured (via the tension of the spring) between the first fastener and the repositionable fastener. Once in this position, at least one locking mechanism can be engaged to prevent movement of the repositionable fastener and/or spring within the channel and/or to prevent movement of the ladder by contacting/engaging the ladder.

The front frame member is also comprised of a channel that preferably runs a length within the frame member. At least one spring is positioned within the channel. More specifically, the spring is attached to a fastener of the frame member. The fastener is preferably an angled bracket with a top surface parallel to a top surface of the frame member that secures a lip of a first edge of a ladder frame to prevent the ladder from falling off a vehicle roof. The device may also have a fastener in the form of a bracket that is perpendicular to a top surface of the frame member that is positioned between rungs of a ladder frame to prevent the ladder from shifting forward or backward off a vehicle roof. The spring is also attached to a repositionable fastener that moves within the channel. The fastener can be pulled away from the first fastener such that the first fastener engages a first edge of a ladder frame once the ladder is placed across the top surface of the member. The repositionable fastener then can be released such that it engages a second edge of the ladder frame, wherein the ladder is then secured (via tension of the spring) between the first fastener and the repositionable fastener. Once in this position, at least one locking mechanism can be engaged to prevent movement of the repositionable fastener and/or spring within the channel. This prevents the repositionable fastener from losing contact with the ladder during use.

Accordingly, the vehicle roof ladder-securing device of the present invention is particularly advantageous as it provides a device for securing a ladder to a vehicle. More specifically, the device prevents movement and shifting of the ladder once attached to the vehicle. In addition, the device allows a ladder to easily and quickly be secured to a vehicle using the device. In this manner, the vehicle roof ladder-securing device overcomes the limitations of existing methods and devices used to secure a ladder to a vehicle that is known in the art.

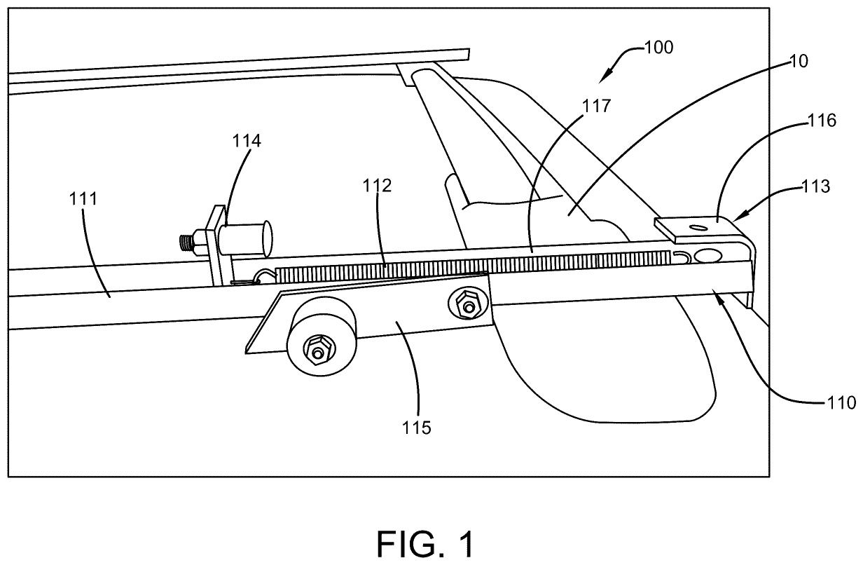

Referring initially to the drawings, FIG. 1 illustrates a rear perspective view of a rear frame member 110 of one potential embodiment of a vehicle roof ladder-securing device 100 of the present invention in accordance with the disclosed architecture. The device 100 is comprised of a rear frame member 110 and a front frame member 120, which each attach to a roof rack 10 (or other area) of a vehicle, wherein each frame member 110 is comprised of at least one spring 112, at least one fastener 113, and at least one locking mechanism 115.

Each frame member 110,120 may be comprised of at least one fastener 102. The fastener 102 allows each frame member 110,120 to be attached to a roof racks 10 of a vehicle in a horizontal position (i.e., across a vehicle). In another embodiment, the fastener 102 allows the frame members 110,120 to attach to any location of any vehicle of any type, wherein the vehicle may or may not have roof racks 10. The fastener 102 may include but is not limited to a clip, a clamp, a mounting bracket, a bolt, a screw, etc. or any combination thereof.

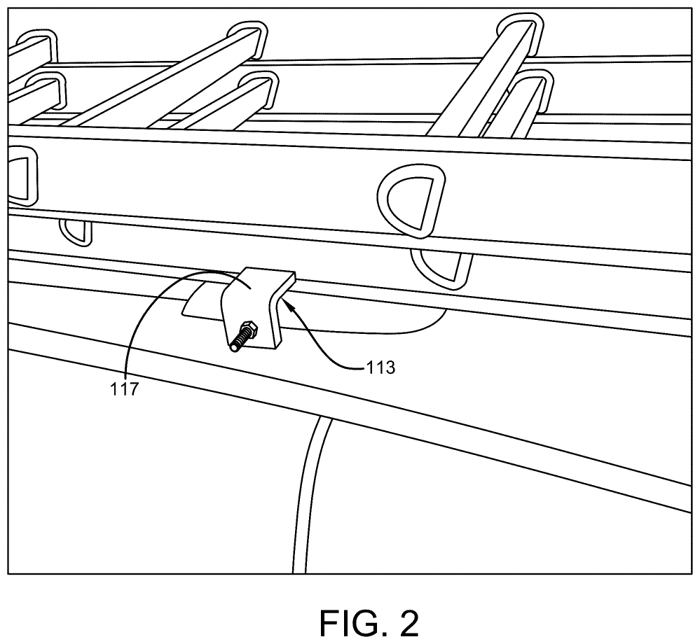

The rear frame member 110 is comprised of a channel 111 that preferably runs a length within the frame member 110, such as but not limited to a full or partial length of the member 110. At least one spring 112 is positioned within the channel 111. More specifically, the spring 112 is attached to a fastener 113 of the frame member 110. The fastener 113 is preferably an angled bracket with a top surface 116 parallel to a top surface 117 of the frame member 110 that secures a lip of a first edge of a ladder frame to prevent the ladder from falling off a vehicle roof, as seen in FIG. 2. The spring 112 is also attached to a repositionable fastener 114 that moves within the channel 111. The fastener 114 can be pulled away from the first fastener 113 such that the first fastener 113 engages a first edge of a ladder frame once the ladder is placed across the top surface 117 of the member 110. The repositionable fastener 114 then can be released such that it engages a second edge of the ladder frame, wherein the ladder is then secured (via the tension of the spring 112) between the first fastener 113 and repositionable fastener 114. Once in this position, at least one locking mechanism 115 can be engaged to prevent movement of the repositionable fastener 114 and/or spring 112 within the channel 111 and/or to prevent movement of the ladder by contacting/engaging the ladder. This prevents the repositionable fastener 114 from losing contact with the ladder during use. The locking mechanism 115 may be any type such as but not limited to a rotating handle lock, a locking button, a locking lever, a locking latch, etc.

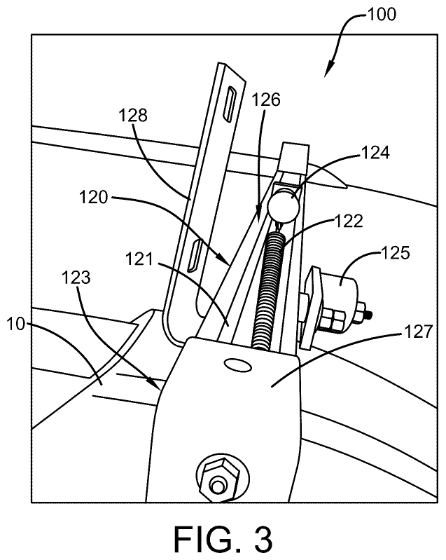

The front frame member 120 is comprised of a channel 121 that preferably runs a length within the frame member 120, such as but not limited to a full or partial length of the member 110. At least one spring 122 is positioned within the channel 121. More specifically, the spring 122 is attached to a fastener 123 of the frame member 120. The fastener 123 is preferably an angled bracket with a top surface 126 parallel to a top surface 127 of the frame member 120 that secures a lip of a first edge of a ladder frame to prevent the ladder from falling off a vehicle roof. The device 100 may also have a fastener 128 in the form of a bracket (as seen in FIG. 3) that is perpendicular to a top surface 127 of the frame member 120 that is positioned between rungs of a ladder frame to prevent the ladder from shifting forward or backward off a vehicle roof. The spring 122 is also attached to a repositionable fastener 124 that moves within the channel 121. The fastener 124 can be pulled away from the first fastener 123 such that the first fastener 123 engages a first edge of a ladder frame once the ladder is placed across the top surface 127 of the member 120. The repositionable fastener 124 then can be released such that it engages a second edge of the ladder frame, wherein the ladder is then secured (via tension of the spring 122) between the first fastener 123 and repositionable fastener 124. Once in this position, at least one locking mechanism 125 can be engaged to prevent movement of the repositionable fastener 124 and/or spring 122 within the channel 121. This prevents the repositionable fastener 124 from losing contact with the ladder during use. The locking mechanism 125 may be any type such as but not limited to a rotating handle lock, a locking button, a locking lever, a locking latch, etc.

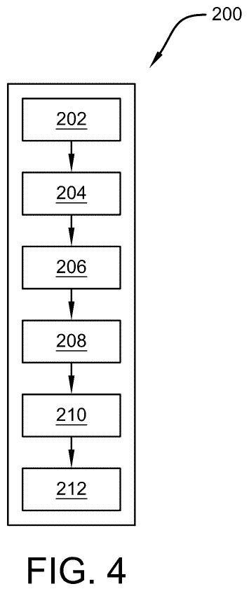

The present invention is also comprised of a method of using 200 the device 100, as seen in FIG. 4. First, a device 100 is provided comprised of a rear frame member 110 comprised of a first channel 111, a first spring 112, a first fastener 113, a first repositionable fastener 114, and a first locking mechanism 115, and a front frame member 120 comprised of a second channel 121, a second spring 122, a second fastener 123, a second repositionable fastener 124, a second locking mechanism 125, and a third fastener 128 [Step 202]. Next, the rear frame member 110 and the front frame member 120 can be attached to a left roof rack 10 and a right roof rack 10 of a vehicle via fasteners 102 [Step 204]. Next, a ladder can be placed on a first top surface 117 of the rear frame member 110 and a second top surface 127 of the front frame member 120 such that the first fastener 113 and the second fastener 123 secure a lip of a first edge of a ladder [Step 206]. Then, the first repositionable fastener 114 and the second repositionable fastener 124 can be pulled along the channels 111,121 (away from the first fastener 113 and the second fastener 123) such that the first repositionable fastener 114 and the second repositionable fastener 124 engage a second edge of a ladder when released [Step 208]. The ladder can then be manipulated such that the third fastener 128 is positioned between a first rung and a second rung of the ladder [Step 210]. Finally, both locking mechanisms 114,125 of both frame members 110,120 can be engaged to secure the ladder to the device 100 [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle roof ladder-securing device” and “device” are interchangeable and refer to the vehicle roof ladder-securing device 100 of the present invention.

Notwithstanding the forgoing, the vehicle roof ladder-securing device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vehicle roof ladder-securing device 100 as shown in the FIGS. are for illustrative purposes only, and that many other sizes and shapes of the vehicle roof ladder-securing device 100 are well within the scope of the present disclosure. Although the dimensions of the vehicle roof ladder-securing device 100 are important design parameters for user convenience, the vehicle roof ladder-securing device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle roof ladder-securing device comprising:
a rear frame member comprised of:
a first channel;
a first spring;
a first fastener;
a first repositionable fastener; and
a first locking mechanism;
a front frame member comprised of:
a second channel;
a second spring;
a second fastener;
a second repositionable fastener;
a second locking mechanism; and
a third fastener.

2. The vehicle roof ladder-securing device of claim 1, wherein the first spring is positioned within the first channel and the second spring is positioned within the second channel.

3. The vehicle roof ladder-securing device of claim 1, wherein the first fastener and the second fastener are comprised of an angled fastener.

4. The vehicle roof ladder-securing device of claim 3, wherein a first top surface of the first fastener is parallel with a second top surface of the rear frame member.

5. The vehicle roof ladder-securing device of claim 3, wherein a third top surface of the first fastener is parallel with a fourth top surface of the front frame member.

6. The vehicle roof ladder-securing device of claim 1, wherein the first spring attaches to the first fastener and the first repositionable fastener.

7. The vehicle roof ladder-securing device of claim 6, wherein the first repositionable fastener is repositionable within the channel.

8. The vehicle roof ladder-securing device of claim 1, wherein the second spring attaches to the second fastener and the second repositionable fastener.

9. The vehicle roof ladder-securing device of claim 8, wherein the first repositionable fastener is repositionable within the channel.

10. The vehicle roof ladder-securing device of claim 5, wherein the third fastener is comprised of a bracket that is perpendicular to the fourth top surface.

11. The vehicle roof ladder-securing device of claim 1, wherein the locking mechanism is comprised of a rotating handle lock, a locking button, a locking lever, or a locking latch.

12. A vehicle roof ladder-securing device comprising:
a fastener;
a rear frame member comprised of:
a first channel;
a first spring;
a first fastener;
a first repositionable fastener; and
a first locking mechanism;
a front frame member comprised of:
a second channel;
a second spring;
a second fastener;
a second repositionable fastener;
a second locking mechanism; and
a third fastener.

13. The vehicle roof ladder-securing device of claim 12, wherein the fastener is comprised of a clip, a clamp, a mounting bracket, a bolt, or a screw.

14. The vehicle roof ladder-securing device of claim 12, wherein the locking mechanism is comprised of a rotating handle lock, a locking button, a locking lever, or a locking latch.

15. The vehicle roof ladder-securing device of claim 12, wherein the first spring is positioned within the first channel and the second spring is positioned within the second channel.

16. The vehicle roof ladder-securing device of claim 12, wherein the first fastener and the second fastener are comprised of an angled fastener.

17. The vehicle roof ladder-securing device of claim 16, wherein a first top surface of the first fastener is parallel with a second top surface of the rear frame member.

18. The vehicle roof ladder-securing device of claim 16, wherein a third top surface of the first fastener is parallel with a fourth top surface of the front frame member.

19. The vehicle roof ladder-securing device of claim 12, wherein the first spring attaches to the first fastener and the first repositionable fastener within the first channel.

20. A method of using a vehicle roof ladder-securing device, the method comprising:
providing a vehicle roof ladder-securing device comprised of a rear frame member comprised of a first channel, a first spring, a first fastener, a first repositionable fastener, and a first locking mechanism, and a front frame member comprised of a second channel, a second spring, a second fastener, a second repositionable fastener, a second locking mechanism, and a third fastener;
attaching the front frame member and the rear frame member to a left roof rack and a right roof rack;
placing a ladder on a first top surface of the rear frame member and a second top surface of the front frame member such that the first fastener and the second fastener secure a lip of a first edge of a ladder to the vehicle roof ladder-securing device;
pulling the first repositionable fastener and the second repositionable fastener along the first channel and the second channel such that the first repositionable fastener and the second repositionable fastener engage a second edge of a ladder when released;
manipulating the ladder such that the third fastener is positioned between a first rung and a second rung of the ladder; and
engaging the first locking mechanism and the second locking mechanism.
